(19) United States
(12) Patent Application Publication
(10) Pub. No.: US 2003/0145296 A1
(43) Pub. Date: Jul. 31, 2003

(54) Formal automated methodology for optimal signal integrity characterization of cell libraries

(76) Inventors: Rajit Chandra, Cupertino, CA (US); Gajanana K. Datta, San Jose, CA (US)

Correspondence Address: PILLSBURY WINTHROP, LLP, 1600 Tysons Blvd., McLean, VA, 22102, US

(21) Appl. No.: 10/323,092

(22) Filed: Dec. 18, 2002

Related U.S. Application Data
(60) Provisional application No. 60/343,018, filed on Dec. 19, 2001.
(60) Provisional application No. 60/350,782, filed on Jan. 18, 2002.

(51) Int. Cl. G06F 9/45; G06F 17/50

(52) U.S. Cl. 716/6; 716/5

(57) ABSTRACT

A method for formal automated signal analysis upon elements of a design of a electronic circuit. The method includes (1) categorizing said elements into one of a plurality of types; (2) initiating a technique for characterizing the immunity of said given element to electrical signal effects, and (3) determining, based on said characterizing, whether a signal integrity violation will occur as a result of said given element, and if a violation will occur, how said violation could be repaired.

### CROSS-REFERENCE TO RELATED APPLICATION(S)

This application claims priority from a provisional patent application entitled “Formal Automated Methodology for Optimal Signal Integrity Characterization of Cell Libraries”, filed on Dec. 19, 2001, and bearing serial No. 60/343,018 and from a provisional patent application entitled “Formal Automated Methodology for Optimal Signal Integrity Characterization of Cell Libraries”, filed on Jan. 18, 2002 and bearing serial No. 60/350,782.

### BACKGROUND

The number of silicon failures due to signal integrity violation is on the rise and the importance of having silicon integrity solutions in the integrated circuit design flow is growing. The reasons for dominance of signal integrity issues in recent times is related to the newer chip manufacturing technologies and the lack of capabilities in the older design tools to effectively address these issues.

The fundamental problem is that timing and functional verification is not complete until the backend effects of signal integrity are already taken into account. The measure of quality of signal integrity verification is a sign-off tool that effectively uses industry accepted tools and methods to certify the end design.

Although timing and signal integrity analysis are critical steps in a design flow, its existence as a separate post-layout activity is complicated by issues of costly design iterations, failed schedules, reduced product performance and often, larger die size and poorer manufacturing yield. For instance, reduced feature size, 0.18-micron and below in Deep Sub Micron (DSM) technologies, has led to “interconnect delay dominated” designs. Due to scaling of interconnect wires, RC delays dominate over cell delays so changes in signal behavior has a major impact on the design quality.

However, unwanted side effects of the technology are increased cross talk noise and lower noise immunity both of which are undesirable for correct functioning of the design. Increased clock frequencies and sharper slew rates combined with lower power supply and threshold voltages are the reasons that contribute to these effects.

FIG. 1 shows components of interconnect capacitance. The scaling of the horizontal dimensions of wires reduces the aspect ratio of horizontal to vertical dimensions, resulting in increased ratios of coupling sidewall capacitance, C_{xcoup}, to substrate capacitances C_{fringe} and Cₐᵣₑₐ. Due to high densities of integration there is also capacitive coupling between metal wires in the vertical direction, as represented by C_{crossover}.

With the scaling of the horizontal dimensions of wires, the aspect ratio of horizontal to vertical dimensions is reduced, resulting in increased ratios of coupling capacitance to the side walls, for instance, C_{xcoup} in FIG. 1, to substrate capacitances C_{fringe} and Cₐᵣₑₐ. Due to high densities of integration there is also capacitive coupling between metal wires in the vertical direction, as represented by C_{crossover}.

When signals in neighboring wires switch, the coupling capacitors cause transfer of charge between them. The charge transfer induces voltage noise peaks on victim wires. The magnitude of this noise is dependent on the relative driver strength of the victim and aggressor as well the mutual and self-capacitance of the wires. The unwanted variations of a signal wire's electrical potential from the assumed steady values of V_{dd} and Vₛₛ provide a measure of the cross talk noise on the wire. The presence of signal noise can lead to functional failure of the design.

Depending on the relative rate of switching (rise and fall times of the signals) and the amount of mutual capacitance there can be significant cross talk noise. Cross talk noise between neighboring signal wires causes two major problems that affect the operational integrity of IC designs:

Cross talk delay changes the signal propagation on some of the nets and may cause setup time constraint violations, illustrated in FIG. 2(a). Reducing achievable clock speed allows extra time for the signals to settle.-The opposite case where signals can be accelerated due to signals switching in the same direction is not shown in FIG. 2(a). Earlier arrival times may cause hold time errors and require insertion of date delays to avoid them.

Cross talk Glitch causes voltage spikes on some nets, resulting in false logic states being captured in the flops, this is shown in FIG. 2(b).

These problems can be solved through altering the strengths of the driver cells, inserting buffers to segment the wires thereby reducing the coupling capacitance, re-ordering the nets so that neighboring nets do not switch simultaneously or nets with weak drivers are not close to the nets with strong drivers, widening the spacing between the wires and shielding special nets such as clock nets. All of these solutions are possible, but the cost for each of the preventive or repair action has an associated cost in run time and silicon area. Fixing crosstalk post-layout is both costly and risky from the point of view of chip design and time to market.

The most advantageous place to fix the crosstalk problems is early during the physical implementation of the design. However, to efficiently achieve concurrent analysis and correction of signal integrity effects it is necessary for the place and route capabilities, to have incremental access to extraction and analysis capabilities. Without the right tool architecture, data driven decisions cannot be taken for optimizing the circuit design with regard to signal integrity issues.

The height of a cross talk noise peak as seen on a net, depends on the output resistance of the driver of the net. This resistance called holding resistance, needs to be characterized under conditions different to that for timing verification. If the noise pulse exceeds the noise margin at the input of the gate then it causes output of the gate to change. The amount of noise that is seen or propagated at the gate's output depends on the output load capacitance, input noise magnitude and the drive strength of the gate. The noise propagation is characterized for the analysis tool to enhance the noise peak as calculated on each net of the design.

To implement a design free of signal integrity problems it is necessary to analyze the noise effects for possible signal integrity violation. To know whether a noise will cause a signal integrity violation, it is necessary to characterize the cross talk noise tolerance levels (noise margins) of each wire.

The calculations involve resistance value of the victim net's driver, which in case of the noise pulse calculation is different from that used in calculating interconnect delays. The value of the holding resistance also needs to be characterized.

The switching activities within electrical circuits cause a range of voltage values to exist on the signal wires. So the logic values of 1 and 0 as discrete values do not occur in practice, instead they map to acceptable ranges of nominal voltage values respectively. Exceeding these ranges at the input pins leads to unwanted changes at the output of the logic gates that can potentially cause the circuit to malfunction. So for any net in the design, the level of the noise margins on the input pins connected to the net can determine the extent of cross talk noise violation.

Traditionally, cross talk noise is analyzed using circuit simulation. For large-scale designs it is extremely inefficient (and mostly impractical) to simulate each node in the circuit to check whether it is operating within the acceptable noise margins.

DC Noise Margin

Whenever an output of a logic gate is connected to the input of another logic gate the output voltage of the driving gate is expected to be within a certain voltage value corresponding to a logic “1” state (V_{OH}) or to a logic “0” state (V_{OL}). The downstream gate will be driven to be at either a “1” or “0” state provided the output of the driver satisfies the nominal voltage value V_{IL} (for “0”) or V_{IH} (for “1”) required to determine its state. The low noise margin is defined as the difference between V_{IL} and V_{OL}, whereas the high noise margin is defined as the difference between V_{OH} and V_{IH}. The state of the logic gate is uncertain if the input voltage is in the region between V_{IH} and V_{IL}. The noise margins regions are shown in FIG. 3, and are termed DC Noise Margins.

FIG. 4 shows a voltage transfer characteristic (also called DC transfer characteristic) curve for an inverter, which is derived by applying DC voltages at the input of the gate and measuring the output voltage. Given a Spice netlist and the transistor model for the inverter it is possible to determine the noise margins by locating the point son the curve where the output changes at a rate equal but opposite to that of the input's (slope value is −1). The input voltages, as shown in the figure, where the slopes are −1 are the V_{IL} and V_{IH} values respectively.

AC Noise Margin and False Error Reduction

While the DC noise margin can be used to provide a conservative estimate for noise there is an associate cost of getting “false errors” due to overestimation of noise. Not all noise peaks that are greater than the noise margin can cause output change of a gate. There needs to be a sufficient energy in the input noise signal to affect output change. The width of the noise (in this case measured at the 50% point of the noise value) can be a determining factor.

FIG. 5 shows the output pulse height (low noise case) of a lightly loaded inverter for varying input noise heights and widths. Note that a wider input noise pulse requires lesser height to produce the same output magnitude of output signal, as represented by the dashed horizontal line. An acceptable level of output signal is dependent on the gate connected to the output of the inverter. Since instance specific connectivity of the library cells cannot be predicted it is better to be conservative and set the level of the horizontal line (noise rejection level) to the least value of the DC noise margins in the library.

By plotting the width of the input noise signal against the noise rejection level yields a single curve for a particular output load. When the experiment is repeated for several of output loads, a family of curves are generated as shown in FIG. 6. Signal values on and above any particular curve are considered violations for the output load value, whereas the ones below the curve can be rejected as a potential violator. That is why the curves are called noise rejection curves and should not be reported as a problem to avoid false error reporting.

### SUMMARY

What is disclosed is a method for formal automated signal analysis upon elements of a design of a electronic circuit. The method includes (1) categorizing a given one of said elements into one of a plurality of types; (2) initiating a technique for characterizing the immunity of said given element to electrical signal effects, said technique appropriate for said categorized type, said technique yielding results capable of being verified by non-automated signal analysis; and (3) determining, based on said characterizing, whether a signal integrity violation will occur as a result of said given element, and if a violation will occur, how said violation could be repaired.

### BRIEF DESCRIPTION OF THE DRAWINGS

These and other objects, features and advantages of the present invention are better understood by reading the following detailed description, taken in conjunction with the accompanying drawings, in which:

FIG. 1 shows components of interconnect capacitance;

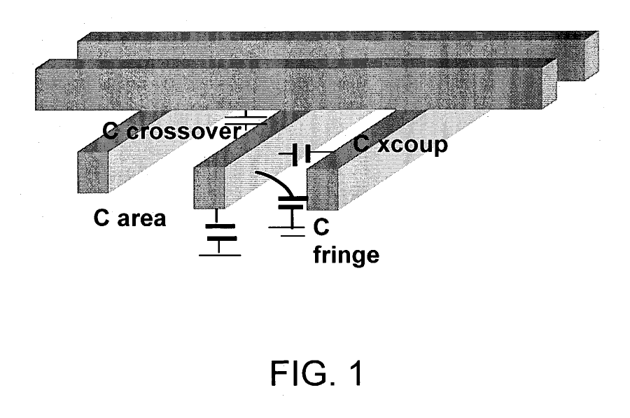

FIG. 2(a) illustrates setup time constraint violations;

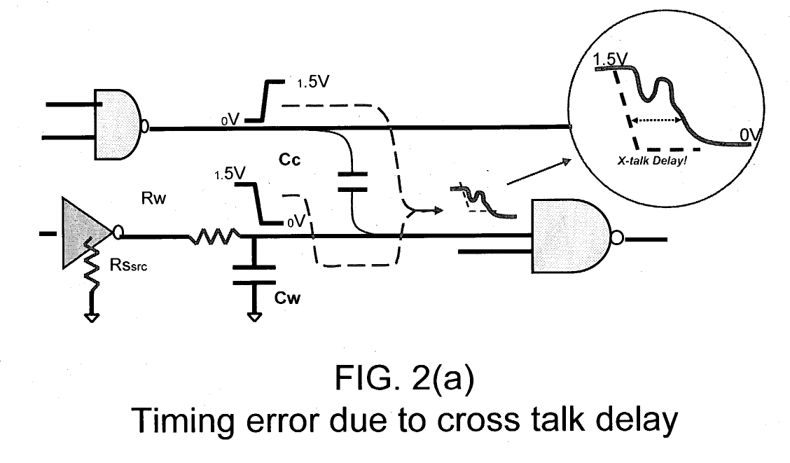

FIG. 2(b) illustrates problem associated with cross-talk glitch;

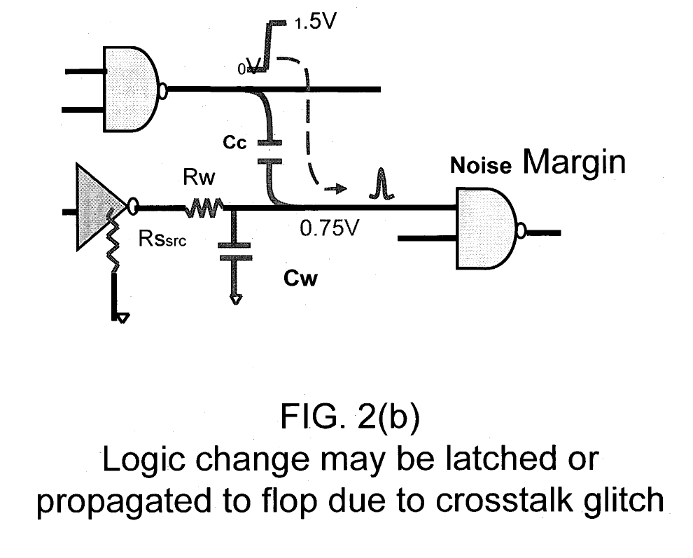

FIG. 3 illustrates noise margin regions;

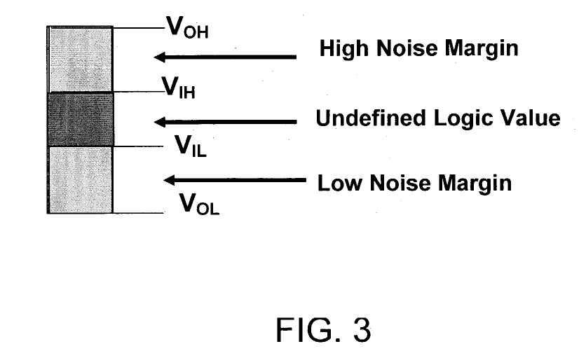

FIG. 4 shows a voltage transfer characteristic curve for an inverter;

FIG. 5 shows the output pulse height (low noise case) of a lightly loaded inverter for varying input noise heights and widths;

FIG. 6 illustrates a family of noise rejection curves;

FIG. 7 illustrates the base methodology employed in various embodiments of the invention;

FIG. 8 illustrates the general topology of CMOS static complementary cells;

FIG. 9 illustrates the general topology of complex static complementary cells;

FIG. 10 illustrates a tri-state cell;

FIG. 11 illustrates resistive loading of a tri-state cell;

FIG. 12 illustrates the signal timing relationships of flip-flops;

FIG. 13 illustrates the variation of the resistance in the case of two logic gates;

FIG. 14 illustrates the setup for characterizing the low and high noise holding resistances;

FIG. 15 illustrates a flip-flop circuit; and

FIG. 16 illustrates a computer system capable of implementing one or more embodiments of the invention.

### DETAILED DESCRIPTION

A methodology is disclosed, parallel to timing verification, where the cell library is pre-characterized for the noise margins at the input pins so that tools can look at the specific environment of each instance of the library cell and verify that the computed noise on the input nets of the cell(s) are within acceptable limits. Based on such an analysis implementation decisions can be made to avoid signal crosstalk noise violations.

The invention, in various embodiments, is directed toward novel techniques for the characterization of circuit elements used in a integrated ciruit design process for the purpose of signal integrity analysis and verification. The techniques described in various embodiments of the invention are “formal” in that they are developed using analytical techniques that ensure that the results are not dependent upon external assumptions or differences in standards. The techniques are automated in that they do not require human intervention or assistance to perform, provided the necessary netlist and functional data, as specified below, is available. The techniques can be decomposed into the following processes. First, the circuit elements in the proposed integrated circuit design are identified as belong to a particular type or grouping (for the purpose of the characterizing technique). For a given circuit element, the technique appropriate it is initiated to determine whether if a signal integrity violation exists and how/if that violation can be repaired.

The techniques involve a charcterization of the immunity of the circuit elements to electrical signal effects. The results of these techniques can be verified by any other techniques or simulations, including non-automated techniques. The categories of circuit elements identified for purposes of the invention include but are not limited to: Standard Cells, Tri-state Cells, Sequential Cells, Macro-cells, Memory/Array Elements, and User-defined. The techniques take as inputs information about the circuit design such as netlists, models for signal effects on circuit elements and functional/timing data for these elements. The techniques produce metrics for detecting violations caused by electrical signal effects which can be used in any analysis or verification tool.

The characterization engine in which these techniques will run, produces as output the following:

1. DC noise margin (peak input value);

2. DC noise peak output value as the minimum of peak output;

3. AC noise margin; and

4. Holding resistances.

Since transistors provide active conducting paths for the electrical signals, their physical dimensions affect the shape of the DC transfer characteristic curve. The channel width and length ratio of the devices are deciding factors in the noise margin of the logic gate. The quantity βn/βp for a given channel length is proportional to the effective widths of the n channel and the p channel of a logic gate. As this ratio is decreased, the DC Characteristic curves are pushed out further to the right and the V_{IL} value is increased while the V_{IH} is decreased.

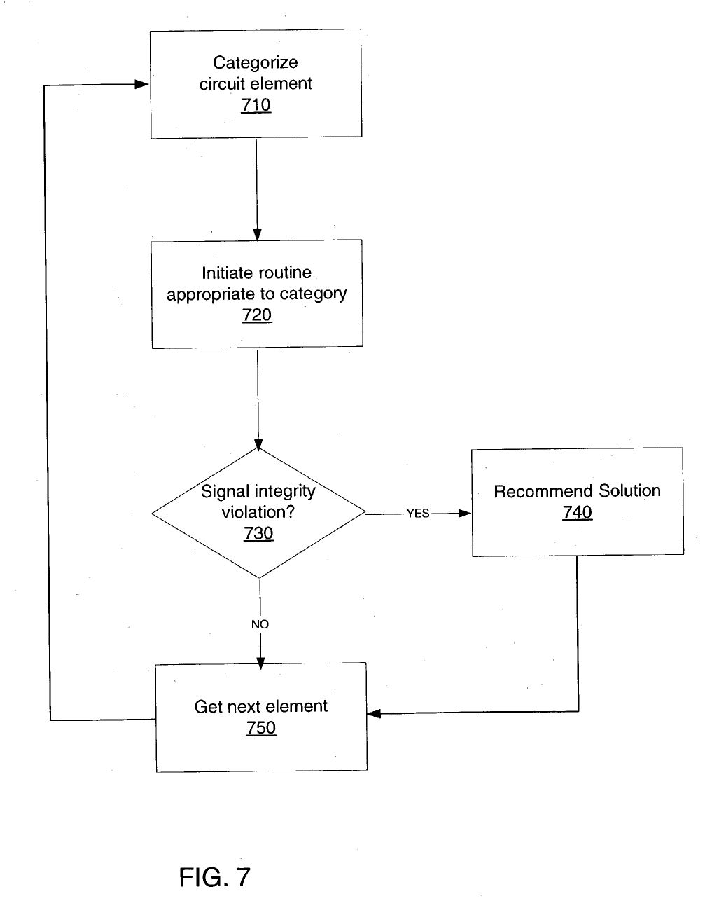

FIG. 7 illustrates the base methodology employed in various embodiments of the invention. The circuit design can analyzed either element by element, cell by cell or group by group as desired. In preferred embodiments, the invention examines the circuit design cell by cell when performing noise characterization. First, according to step 710, the cell being examined is categorized. The categories of cells which are considered is detailed below, but categories can be augmented, redefined, supplemented or removed as fits the needs of the design or process under examination. Once the category of cell is determined, a noise characterization analysis routine appropriate to that category of cell is initiated (step 720).

The noise analysis routine generates parameters which enable a determination of whether a signal integrity violation may occur (checked at step 730). If a violation may occur (when the design is implemented), then the system can recommend a solution to the potential violation (step 740). If there is no signal integrity violation, and after a solution has been recommended for a potential signal integrity violation, then the next cell is fetched from the design (step 750) and steps 710 through 740 are repeated upon it. In the case of a recommended solution calling for a cell replacement/correction, steps 710-740 can be repeated upon that replaced/corrected cell.

Standard Cells

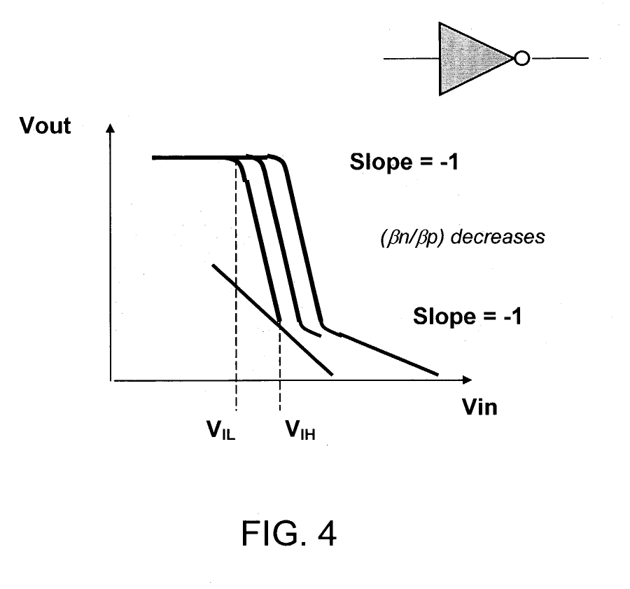

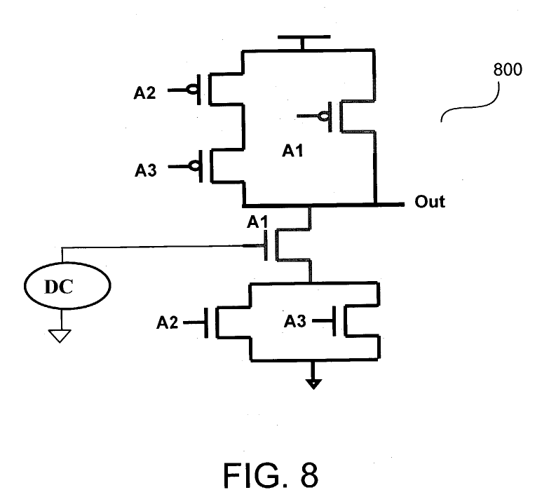

Generating DC Noise Margin data is as follows. Standard Cells are defined as any static complementary cells such as CMOS cells. The transfer curve illustrated in FIG. 4 is shown for an inverter but can be applicable to all static complementary CMOS gates. Like the inverter example of FIG. 4, the general topology of CMOS static complementary cells consists of a pull-up PMOS transistor network connected to a pull-down NMOS transistor network. This is shown in FIG. 8. The charcteristics of such networks are as follows. The pull up and pull down networks are usually dual circuits where the series connections of transistors in one network have respective parallel connections in the other network. The dual nature of the circuits is utilized in the automatic characterization capability. A single stage complementary gate is inverting. So a rising input signal causes the output to fall and vice versa. Non-inverting gates have an inverter connected to the single stage. Both inverting and non-inverting gates are characterized using the techniques various embodiments of the invention.

From the point of view of a switching input signal such as A1, the circuit 800 in FIG. 8 operates as an inverter as long as the values on the rest of input signals (A2 and A3, also called side inputs) are set to enable the output to transition. The gate can be thought to be equivalent to an inverter with the effective dimensions of the pull-up PMOS pull-down NMOS transistor network.

Since the dimension of the pull-up and pull-down transistors influence the shape of the DC transfer curve, and the DC noise margin values, the signal values required to sensitize the side inputs also affect the value of noise margins. The automated method of characterization that causes the βn/βp to be maximum for the V_{IL} and minimum for the V_{IH} will provide the most conservative values for the noise margin. While such analysis reduces the risk of detecting noise violations, it can also yield false errors. Therefore the characterization capability allows users to provide non-conservative V_{IL} and V_{IH} values if needed. The default is conservative.

For example, in case of the circuit 800 in FIG. 8 the βn/βp is maximized by maximizing the effective width of the n tree by setting A2 and A3 to logic 1 value to get a conservative value of V_{IL}. In other words, to get V_{IL}, vary the DC voltage on the input A1 from low to high in steps while keeping A2=A3=1. Then measure the Vout, the voltage at the output (Out) of the gate and calculate the unity gain point. This goves the low DC noise margin.

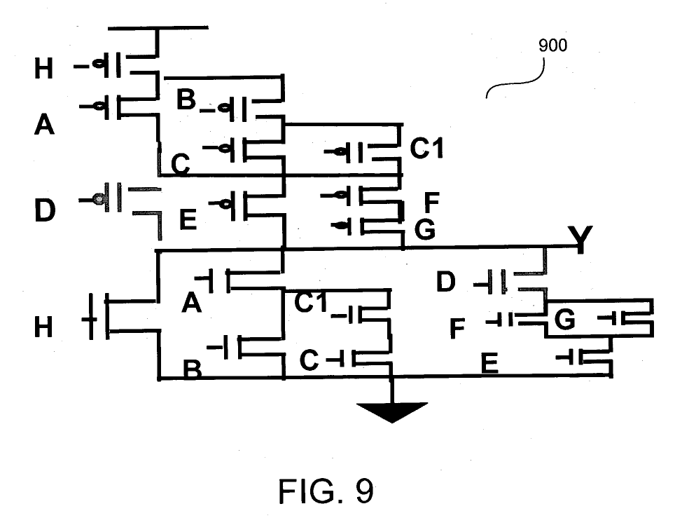

In a more complex gate 900 as shown in FIG. 9 the p transistors H, B, Cl are sensitized to logic “0” while switching the D input during the DC characterization. The function βn/βp is maximized for the conservative value of VIL. A converse set of sensitization vectors are used for the side input signals for the VIH characterization such that a conservative value can be obtained. In case of the complex gate 900 in FIG. 9, for switching input D, the transistors F,E and G are set on in the n tree to provide max Wn while H, B, Cl is on in the p tree because it provides the minimum Wp based on the rise delay table. The automation of the vector generation is achieved by using the function description of the cell in the synthesis library and by use of the path delays through the cell as specified in the delay tables of the cell in the timing library.

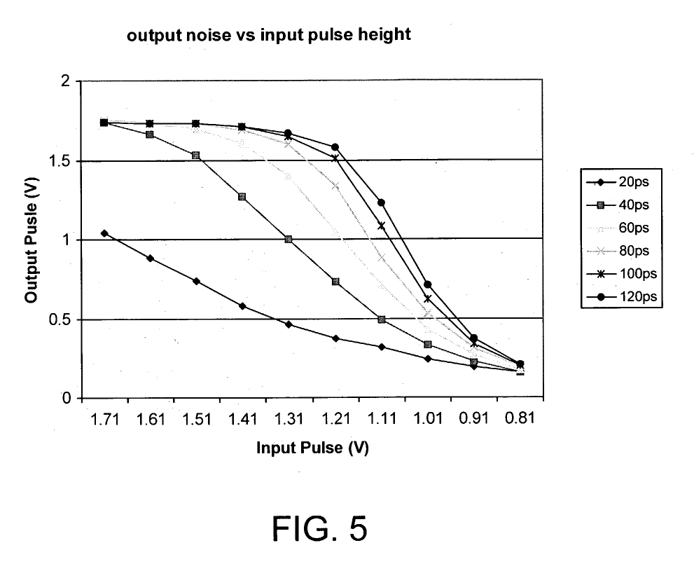

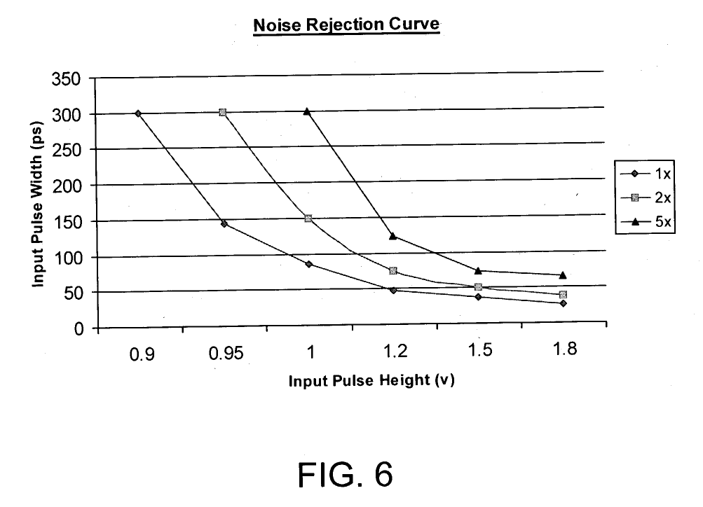

Generating of the AC Noise Rejection curves for static cells is as follows. The automation of the AC Noise Rejection data is achieved through first running the DC noise margins in the library to obtain a value for the noise rejection level. For each switching input pin the vector set of the side input pins are chosen according to the method described for the DC Noise margin characterization. The switching input is then subjected to simulation using triangular waveforms. The triangle height is varied in regular intervals from the rail voltage to the DC noise rejection level. The width of the triangle is determined by using the signal transition times as specified in the timing library for the cell, the width being measured at 50% of the height. The width of the pulse is constructed from the linear waveforms implied by the transition times in the data tables associated with the input of the cell, in the timing library. Each transition time yields a particular signal width and a family of curves is generated as shown in FIG. 5. Then using the load values in the timing table a family of noise rejection curves are generated for the gate as shown in FIG. 6.

Users can change the default setting for noise rejection level. Also, in the event a user wants to derive values at the cell level for the noise rejection curve rather than at the pin level, there are configurable options provided to choose the pin that produces the worst-case result to represent the gate level data. The default is to let the tool automatically collect data for-all pins and select the worst- case values for the cell level.

Tri-state Cells

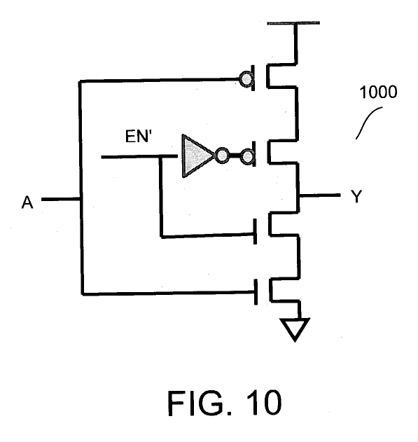

Tri-state cells have a state where they provide high impedance output, in addition to the high and the low state. The characterization methods for these cells therefore require additional procedures. For example, in a tri-state cell 1000 of the type shown in FIG. 10, the enable line EN′ sets the output in the tri-state mode when it is in the logic 0 state. When the output is not in the tri-state mode (EN′=1 state in FIG. 10) the gate behaves like an inverter and all noise margins for the input A are computed as described in the foregoing discussions.

The noise on the enable line EN′ (at 1 state) can however causes the gate to change state to tri-stated output. The noise margin for this case can be computed by varying the height of the low voltage noise peak until Y changes state, which happens when the inverter changes state. The height at which this happens is a measure of the DC (high) noise margin for EN′. The minimum of the heights of the voltage peaks of the two cases, when A=1 and when A=0 respectively, is used as a conservative estimate. The AC noise margin is characterized using the slews from the timing table. The AC margin is dependent in this case (where the output is switching to tristate) on the output load of the gate.

DC noise margin for EN′ in 0 state is similarly obtained. The AC noise margin on EN′ when it goes from inactive to active state (0 to 1 in FIG. 10 where the output is switching from tri-state) is output load independent. The range of slews on EN′ is specified in the timing table and can be used to generate the AC noise margins curve using the output load range to generate the load dependency.

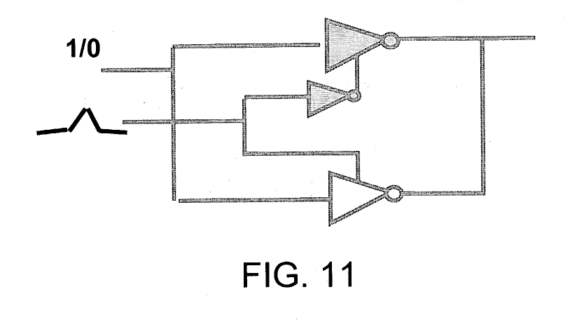

The tri-state devices are connected in parallel with their output tied via a small resistance value. The inverter drives a fixed gate load and is chosen to be the minimum size for speed reasons. The basic circuit configuration is shown in FIG. 11. Is this for holding resistance? please confirm.

Sequential Cells

Sequential Cells can be defined as latches, flops and other cells that are triggered by clocking action. The techniques for these type of cells differ based on the input to output pin relations. These relations are captured in the timing models and therefore can be re-used for the purpose of noise characterization. They are:

Function: e.g. edge triggered ff, level sensitive latches (scan and data input logic from library);

Signal Types: e.g. clock, data, scan, scan enable, etc.;

Timing Type: e.g. rising/falling edge of clock, preset, clear, setup, hold, recovery (provides output to input pin relationship);

Timing Data: e.g. Setup, Hold times, Recovery times, Signal Slews, Minimum Pulse Width to optimize simulation

Timing sense—provides unate attribute

Sequential cells have wide variations and can include differences in clocking schemes, and the presence of a scan input, asynchronous input, buffered, and un-buffered outputs. Some cells have custom features that require special characterization methods. However, majority of sequential cell circuits have common features which allow predetermined procedures to be used in their noise characterization.

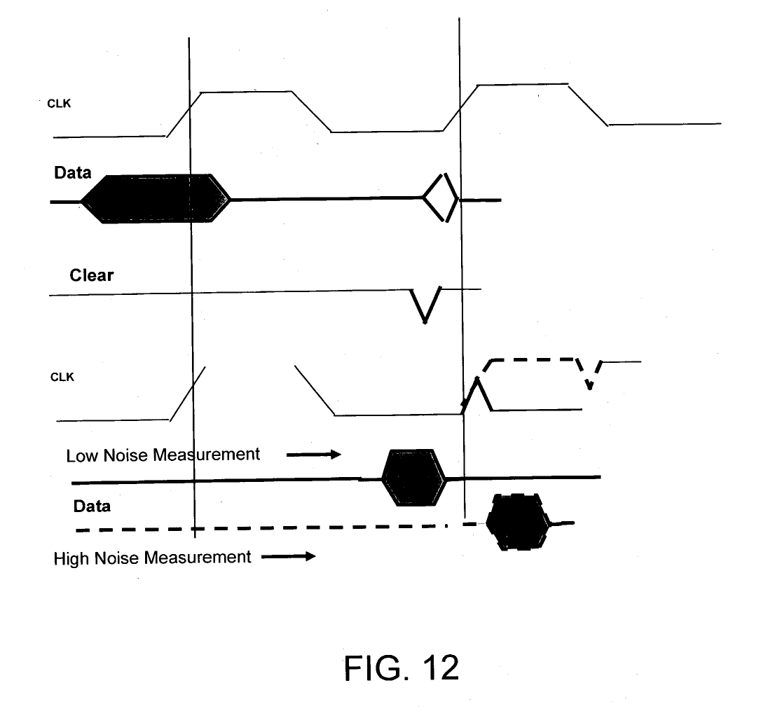

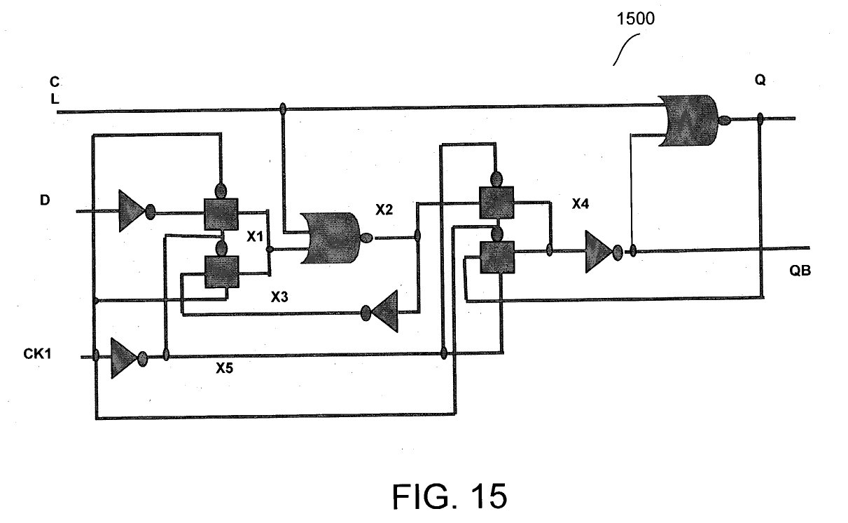

To illustrate the characterization of a basic flip-flop (shown in FIG. 15), the signal timing relationships required are shown in FIG. 12. The principle of noise margins characterization on the Data line is to first deterministically clock a data value into the cell and then inject noise on the steady data line within the setup time, with changing width and height until the Q shows a change in state. Both DC and AC noise margins are derived using this method.

The Clear line is asynchronous and the effect of noise on it can cause Q to go low for a high noise pulse or to go high for a low noise pulse. The height and width of clear is varied while measuring the proper minimum or maximum output on Q as specified by the unate relation between Q and Clear. The noise on the clock signal, CLK, is measured by changing the value of D and then applying noise on the clock line while measuring corresponding changes at Q. Note that the time of D's change is different in the two cases for high and low noise respectively.

To optimize the number of simulation (such as a SPICE simulation) trials, the minimum pulse width information is used to bound the width of the pulse where applicable. The variation of the input slew and output load are read in from the timing library data as the minimum pulse width. The clock period and the duty cycle is input to the tool to set the clock for the simulations.

In the case of JK, FF and RS latches, the user will need to indicate the equivalence of the input to any user defined names if the default terminology is not used. The characterization requires precise pin definitions for correct application of the stimulus and measurement statements.

In the case of JK and RS flip-flops and latches, the waveforms applied to the respective input pins uses the truth tables to determine the changes in the output. The default names can be used to identify them. If however the flip-flops and latches use other names, then the equivalence between these pins and the expected names needs to be established.

As can be seen from FIG. 12, the underlying semantics of the sequential gate behavior is hard-wired into the characterization tool. A good example is the enable pin of a flip-flop, which allows the device to be isolated when the enable is inactive. The measurement of noise on the enable pin is along the lines of what is described above. However, the reverse situation where the enable line of the device has noise injected such that it is disabled, means that the output will continue to be in its previous state. In such a case, the technique looks for the absence of an output change in order to characterize the noise margin. Such change in trend of measurements may not always be evident. The technique may then expect more data from the user to be correctly characterized. In the absence of such user input, the technique returns the worst-case noise margin of the pin for all other measurements. If there is no other noise margin possible, then it returns an empty set.

The technique provides user defined specification of the input and several other properties that set the simulation conditions based on the semantics of the basic sequential circuit operation. Custom circuits may need to be handled differently. In genreal, for any type of cutom or pre-defined circuit elements, the technique can be configured with externally or user input slew rates, output loads, side input vectors, truth tables, noise measurement points, output rejection levels, voltage and temperature constraints and so on as is desired.

Holding Resistance

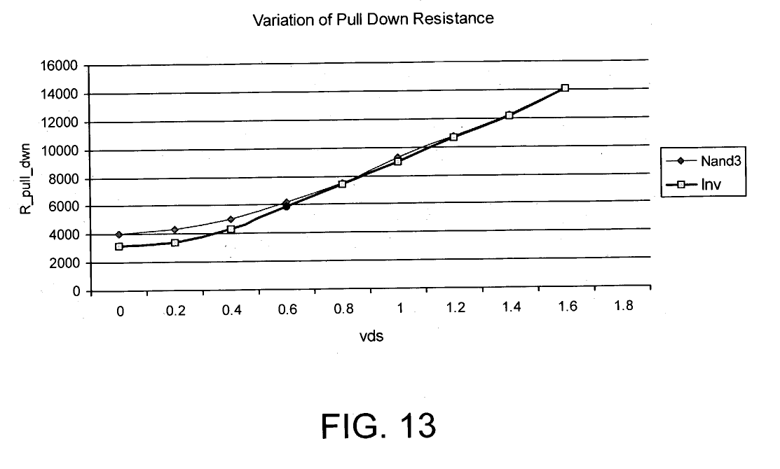

The output of a victim net driver is forced to change by the induced noise voltage, while the driver input is maintained at a steady voltage value. The variation of the resistance in the case of two logic gates is shown in FIG. 13. As can be seen from the picture the resistance variation can be large based on the height of the induced noise.

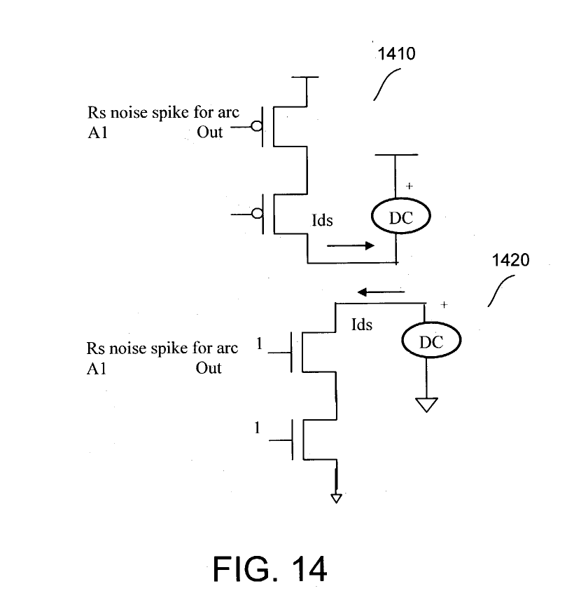

The DC characterization is useful in both providing a worst-case value and a table lookup capability. The characterization required for the analysis uses the worst case value today. The setup for characterizing the low and high noise holding resistances is shown in FIG. 14 in circuits 1410 and 1420, respectively. The input vectors are set to provide the minimum Wn and Wp effective width for the low and high noise calculations, respectively, using available timing data. DC step voltage is applied as shown. The output current is then measured yielding a maximum value or a table of values for the output resistance. The “1s” in FIG. 14 are the logic state specification for the examples shown. It corresponds to the high voltage value.

Noise Propagation

The propagation of a noise pulse from the input of a gate to the output is evident during simulation. However when static methods are used for noise analysis the amount of noise that propagates from the input to the output pin of a gate needs to be characterized for each cell as a function of the output load and input noise height in order to estimate its magnitude. The propagated noise is added to the noise computation at the output net of the gate in the design to account for it.

In digital logic the steep gain of the transfer characteristic means that above a nominal voltage height at the input, the output changes rapidly. Using the AC noise characterization methods, the minimum output voltage that is above a minimum threshold is recorded in a table lookup. The default threshold is 0.1 percent of the rail voltage. For a coarse grain analysis, a library level or cell level number output propagation pulse height can be used.

As an extension of the user-defined capability provide means to identify topological templates for users to specify measurement points and functional and temporal relations. The use of isomorphism to identify sub-graphs is applied in applications like electrical rule checking and can be used here to write simulation decks for noise characterization.

To illustrate the point consider the flip flop circuit in FIG. 15, transistor level tools can detect the basic feedback loop in a master slave flip flop and can set up vectors that can measure the effect of input signal change. In this case measure at the X3 point, setting CL and CK1 low, and at X3 and Q for noise margin on CL and at X5 for noise margin characterization of CK1. Given variations on this basic topology the tool can detect measurement points, trace the logic and thereby write out simulation applications with input stimulus for noise characterization. Dynamic latch structures could also be handled in a similar manner.

Macro-cells

The approach is to flatten the netlist and reconstruct the logic using the Circuitscope technology disclosed in U.S. patent application Ser. No. 09/528,088 for “System and Method for Performing Assertion Based Analysis of Circuit Design”, and then characterize the noise margins for logic cells that result from the flattening using the other techniques described above and below.

User-defined (Custom) Cells

Noise characterization of custom or user-defined cells are done using template matching of the cells and using user-defined stimulus and measurement points for simulating the custom circuits and obtaining the noise margins.

Custom cells are recognized and then analyzed using the “Circuitscope” technology (see U.S. patent application Ser. No. 09/528,088 for “System and Method for Performing Assertion Based Analysis of Circuit Design”). The circuits are sensitized based on the above mentioned techniques and the vectors generated for simulation for the DC, AC and holding resistance measurement.

User defined circuit patterns are recognized using subgraph isomorphic pattern recognition methods which are build into the Circuitscope technology. Once recognized the user defined patterns and measurements points are inserted into the simulation netlist. The output from simulation is proceeed to obtain the DC, AC noise margins and holding resistances of the user defined circuits.

Memory/Array Elements

Similar to user defined capability applied to specifying the stimulus and measurement points in memory/array element noise characterization. The memory arrays have interfaces which are standard cell circuits. The circuitscope technology is used for flattening and recognizing the stand cells at the memory interface. The noise margins and holding resistance of these circuits are computed using methods defined above.

The methods-applied for noise characterization of core elements of the memory array, whether static or dynamic memory, are same as those for user defined circuits. The user provides the vectors and measurement for the memory cells and sense circuits. The tool works on a single element of the memory array and the rest of the memory is modeled as resistive and capacitive load. Since the loading is dependent of the circuit tooplogy and is dependent on the state of the memory (such as read, write) the user needs to specify the states for which the noise characterization is required by setting the proper values on the memory control lines.

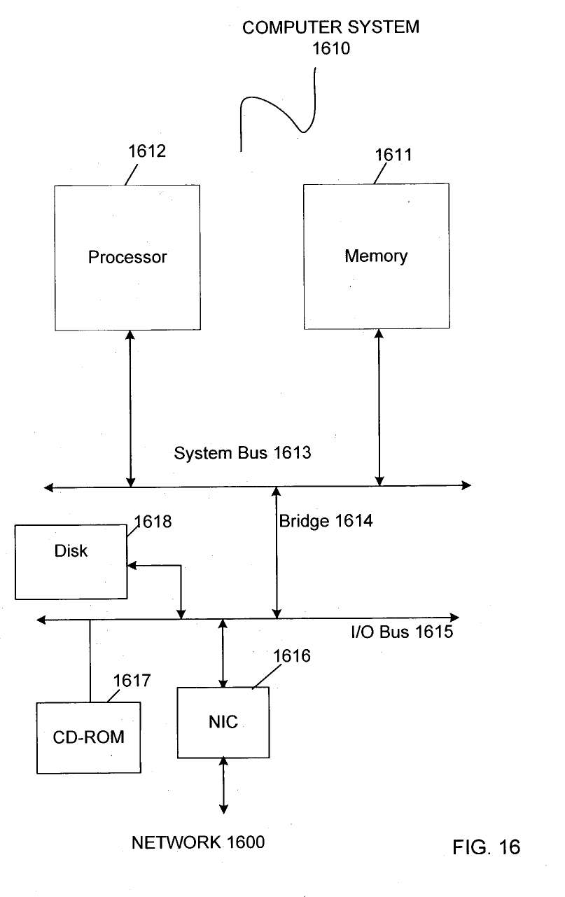

FIG. 16 illustrates a computer system capable of implementing one or more embodiments of the invention. Illustrated is a computer system 1610, which may be any general or special purpose computing or data processing machine such as a PC (personal computer) which can optionally be coupled to a network 1600. The memory 1611 of computer system 1610 may be insufficient to budget the entire circuit design and thus, the budgeting process may need to be broken up. In this way, pieces of the budgeting can be handled by several different computer systems each of which may be similar to computer system 1610.

One of ordinary skill in the art may program computer system 1610 to perform the task of automated signal integrity characterization as set forth in various embodiments of the invention. Such program code may be executed using a processor 1612 such as CPU (Central Processing Unit) and a memory 1611, such as RAM (Random Access Memory), which is used to store/load instructions, addresses and result data as needed. The application(s) used to perform the functions of signal integrity characterization may derive from an executable compiled from source code written in a language such as C++. The executable may be loaded into memory 1611 and its instructions executed by processor 1612. The instructions of that executable file, which correspond with instructions necessary to perform signal integrity and noise characterization analysis, may be stored to a disk 1618, such as a floppy drive, hard drive or optical drive 1617, or memory 1611. The various inputs such as the netlist(s), constraints, delays, capacitances, wire models, cell libraries, measurement points, stimulus points, user-defined cells, slew and timing tables, and other such information may be written to/accessed from disk 1618, optical drive 1617 or even via network 1600 in the form of databases and/or flat files.

Computer system 1610 has a system bus 1613 which facilitates information transfer to/from the processor 1612 and memory 1611 and a bridge 1614 which couples to an I/O bus 1615. I/O bus 1615 connects various I/O devices such as a network interface card (NIC) 1616, disk 1618 and optical drive 1617 to the system memory 1611 and processor 1612. Many such combinations of I/O devices, buses and bridges can be utilized with the invention and the combination shown is merely illustrative of one such possible combination.

The present invention has been described above in connection with a preferred embodiment thereof; however, this has been done for purposes of illustration only, and the invention is not so limited. Indeed, variations of the invention will be readily apparent to those skilled in the art and also fall within the scope of the invention.

1. A method for formal automated signal analysis upon elements of a design of-a electronic circuit, comprising:
categorizing a given one of said elements into one of a plurality of types;
initiating a technique for characterizing the immunity of said given element to electrical signal effects, said technique appropriate for said categorized type, said technique yielding results capable of being verified by non-automated signal analysis; and
determining, based on said characterizing, whether a signal integrity violation will occur as a result of said given element, and if a violation will occur, how said violation could be repaired.

2. A method according to claim 1 wherein the steps of categorizing, initiating and determining are repeated for various other of said elements of said circuit design.

3. A method according to claim 1 wherein said elements are cells.

4. A method according to claim 1 wherein said types include standard, tri-state, sequential, macro-cell, memory/array elements and user-defined.

5. A method according to claim 4 wherein said techniques involve generating DC noise margin data, AC noise margin data and holding resistances for said given cell.

6. A method according to claim 5 wherein if said categorized type is standard, then said generating DC noise margin data includes:
maximizing a beta function, said beta function representing the ratio of the effective width of the n channel of gates within a given cell, for said given cell to obtain a first voltage level, said first voltage level the upper limit of a low DC noise margin for said given cell; and
minimizing said beta function for said given cell to obtain the lower limit of a high DC noise margin for said given cell.

7. A method according to claim 6 wherein said low DC noise margin is the difference between said first voltage level and the voltage level at the output of said cell if said cell is driven to a low logic level, and wherein said high DC noise margin is the difference between said lower limit and the voltage level at the output of said cell if said cell is driven to a high logic level.

8. A method according to claim 6 wherein said DC noise margin is the region between the high DC noise margin and the low DC noise margin.

9. A method according to claim 5 wherein if said categorized type is standard, then said generating said AC noise margin data includes:
running said DC noise margin data in a library to obtain a noise rejection level;
choosing a vector set for each switching input in said given cell according to DC noise margin generation;
subjecting said switching inputs to simulation using triangular waveforms; and
generating a family of noise rejection curves using load values.

10. A method according to claim 9 wherein said triangular waveforms are determined by varying the triangle height and determining the triangle width as a function of signal transition times.

11. A method according to claim 9 wherein said switching inputs include at least one of pins and gates within said given cell.

12. A method according to claim 5 wherein if said categorized type is tri-state, then said generating DC noise margin data for an enable line of said given cell includes:
varying a height of a low voltage noise peak until the output of said given cell transitions to a tri-state mode even though said given cell is not configured to be in a tri-state mode, the height at which said transition occurs being the high DC noise margin for said enable line of said given cell.

13. A method according to claim 5 wherein if said categorized type is sequential, then said generating DC noise margin data and AC noise margin data for a data line of said given cell includes:
deterministically clock a data value into said given cell; and
inject noise on said data line within a setup time of said given cell, said noise injected with changing height and width until a output line of said given cell shows a change in state.

14. A method according to claim 5 wherein if said categorized type is sequential, then said generating DC noise margin data and AC noise margin data for a clear line of said given cell includes:
varying the height and width of a clear signal asserted on said clear line;
measuring the minimum and maximum values on an output of said given cell in response to said asserted clear signal; and
comparing said measured values with values expected by a defined relation between said clear line and said output.

15. A method according to claim 5 wherein if said categorized type is sequential, then said generating DC noise margin data and AC noise margin data for a clock line of said given cell includes:
changing a signal asserted on a data line;
while changing said signal asserted on said data line, applying noise on said clock line; and
while applying noise on said clock line, measuring corresponding changes in the state of an output of said given cell.

17. A method according to claim 5 wherein if said categorized type is macro-cell, then said generating includes:
flattening the netlist associated with said macro-cell; and
characterize noise margins for any cells other than said given cell resulting from said flattening.

18. A method according to claim 5 wherein if said categorized type is memory/array element, then said generating includes:
flattening the netlist associated with said given cell; and
characterize noise margins for cells other than said given cell resulting from said flattening at the interface of said given cell.

19. A method according to claim 5 wherein if said categorized type is user-defined, then said generating includes:
flattening the netlist associated with said macro-cell; and
characterize noise margins for any cells other than said given cell resulting from said flattening.

20. A method according to claim 19 wherein said generating further includes:
using externally provided stimulus points and measurement points for said given cell to perform simulations for said noise characterization;
identifying equivalents of said cells resulting from said flattening, said equivalents having known noise characterization techniques; and
applying said noise characterization techniques appropriate to said identified equivalents.

21. A method according to claim 18 wherein said generating further includes:
using externally provided stimulus points and measurement points for said given cell to perform simulations for said noise characterization; and
modeling all elements resulting from the flattening of said given cell other than those at the interface of said given cell as a resistive and capacitive load.

22. An article comprising a computer readable medium having instructions stored thereon which when executed causes formal automated signal analysis upon elements of a design of a electronic circuit, said analysis including:
categorizing a given one of said elements into one of a plurality of types;
initiating a technique for characterizing the immunity of said given element to electrical signal effects, said technique appropriate for said categorized type, said technique yielding results capable of being verified by non-automated signal analysis; and
determining, based on said characterizing, whether a signal integrity violation will occur as a result of said given element, and if a violation will occur, how said violation could be repaired.

23. A method for formal automated signal analysis upon elements of a design of a electronic circuit, comprising: categorizing a given one of said elements into one of a plurality of types;
initiating a technique for characterizing the drive strength in terms of its electrical resistance of said given element to electrical signal effects, said technique appropriate for said categorized type, said technique yielding results capable of being verified by non-automated signal analysis; and
determining, based on said characterizing, a table of resistance values used in determining the magnitude of signal integrity violation that will occur as a result of said given element, and if a violation will occur, how said violation could be repaired.
